(19) United States
(12) Patent Application Publication
(10) Pub. No.: US 2011/0002253 A1
(43) Pub. Date: Jan. 6, 2011

(54) METHOD FOR MANAGING POWER SAVING OPERATION IN WIRELESS COMMUNICAITON SYSTEM

(76) Inventors: Jae Sun Cha, Daejeon (KR); Chul Sik Yoon, Seoul (KR); Sunggeun Jin, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/919,961

(22) PCT Filed: Oct. 13, 2008
(86) PCT No.: PCT/KR08/06025

§ 371 Date: Aug. 27, 2010

(30) Foreign Application Priority Data
Feb. 28, 2008 (KR) 10-2008-0018398
Jul. 11, 2008 (KR) 10-2008-0067450

(51) Int. Cl. G08C 17/00

(52) U.S. Cl. 370/311

(57) ABSTRACT

In a power saving operation management method in a mobile communication system, a base station receives a sleep mode entering request message from a mobile station desiring to enter the sleep mode, determines a sleep period type and a parameter by analyzing a combination of radio channels between the mobile station and the base station, and transmits a sleep mode entering response message including the sleep period type and the parameter.

### TECHNICAL FIELD

The present invention relates to a power saving operation management method in a mobile communication system, and particularly, it relates to a power saving operation management method using a sleep mode in a wideband wireless access system.

### BACKGROUND ART

A wideband wireless access system represents a next generation communication scheme for further supporting mobility in addition to the local area data communication scheme using a fixed access point in a like manner of the conventional wireless LAN. The wideband wireless access system provides a seamless data communication service by guaranteeing mobility when a mobile station moves from one cell managed by a current base station to another cell managed by another base station.

Further, since a battery is mainly used as a power supply of the mobile station, the battery duration of the mobile station becomes a big limit of the service usage time.

Therefore, the wideband wireless access system supports a sleep mode for stopping all devices in a terminal for the purpose of saving power when there is no uplink/downlink traffic in order to minimize power consumption of the terminal. In the wideband wireless access system, since radio channels that are established between the terminal and the base station have different qualities of service (QoS) according to the traffic characteristics of the respective radio channels, power saving classes are introduced to individually manage the sleep window for each radio channel for the purpose of efficiently managing the sleep mode.

FIG. 1 shows a flowchart of performing a conventional sleep mode operation. As shown in FIG. 1, when a mobile station operating in the awake mode attempts to enter the sleep mode, the mobile station transmits a sleep mode request message (SLP-REQ) to the base station, and the base station transmits a sleep mode response message (SLP-RSP) to approve the sleep mode.

When receiving a sleep mode approval from the base station, the mobile station enters the sleep mode during the initial sleep window starting from the sleep mode entering time. When the initial sleep window is passed, the mobile station is switched to the listening mode to check whether there are data that stands by for transmission during the sleep window from the base station during the listening window. The sleep window represents a section in which the mobile station is operated in the sleep mode, and the listening window represents a section in which the mobile station is operated in the listening mode.

In this instance, when there are no waiting data during the initial sleep window, the base station sets a message for indicating existence of data traffic as 0 and transmits the same to the mobile station. After checking that no data traffic is transmitted during the listening mode, the mobile station enters the sleep mode again. In this instance, the sleep window may be the same as or different from the initial sleep window according to the power saving class type.

When downlink data standing by for transmission to the mobile station during the sleep window exists, the base station buffers the downlink data, and notifies existence when the mobile station is switched to the listening mode. When checking that there are downlink data in the listening mode, the mobile station stops the sleep mode, enters the awake mode to receive the buffered downlink data, and communicates data with the base station.

When there are no downlink data to be transmitted to the terminal, the mobile station maintains the sleep mode to prevent undesired power consumption.

FIG. 2 shows an available section and an unavailable section of the mobile station operable in the sleep mode. Here, the mobile station includes power saving class 1 and power saving class 2, and the power saving class 1 has a characteristic of the power saving class type I and the power saving class 2 has a characteristic of the power saving class type II. The power saving class type I targets best effort service or non real-time traffic service with variable data rate, and the power saving class type II targets VoIP service or real-time traffic service with variable data rate.

The unavailable section represents a section in which all power saving classes included by the mobile station are the sleep mode and all the devices in the mobile station are stopped to enter the power saving mode, and the available section indicates a section in which at least one power saving class in the terminal stays in the listening mode, the terminal does not enter the power saving mode, and the operation of the radio channels in the sleep mode is stopped.

As shown in FIG. 2, the power saving class in the mobile station updates the sleep window according to the corresponding power saving class type.

When downlink data are generated, the conventional art only determines whether to transmit downlink data in the listening window and stop the sleep mode of the power saving class based on the listening window of the corresponding power saving class. That is, when the downlink data are generated to the radio channel belonging to the power saving class 1 while the power saving class 1 is operated in the sleep mode, the base station determines whether to transmit the downlink data to the terminal based on the listening window of the power saving class 1. Having determined that it is impossible to transmit data to the downlink in the listening window of the power saving class 1, the base station transmits a traffic notice message to stop the sleep mode of the power class 1. However, the sleep mode operation of another power saving class set in the terminal is not terminated.

When the sleep mode is managed as the above described, the available section only exists as soon as the power saving class 1 awakes from the sleep mode, and the power saving efficiency of the terminal generates the same effect as the case in which the terminal is operated in the awake mode. However, since the operations of the other power saving classes are not stopped, it is unnecessarily needed to manage the listening window and the sleep window according to the sleep mode management methods of the other power saving classes.

Also, since the conventional art manages the length of the listening window, additional process time delay or data loss may occur when transmitting and receiving a control message that intermittently occurs, responding to a bandwidth request for an uplink, or operating a hybrid automatic repeat request (HARQ).

FIG. 3 shows a flowchart for a HARQ operation when the sleep mode is operated in a conventional wideband wireless access system. In the second listening window section, the base station has transmitted the data 2 to the terminal, and the terminal having received the data senses an error of the received data and transmits a NACK feedback to the base station. Having received the NACK feedback from the terminal, the base station retransmits the same data as those that were previously transmitted to the terminal. The terminal having received the retransmitted data must transmit an ACK or NACK feedback depending on the data receiving state, but it cannot transmit a HARQ feedback since the current power saving class is changed from the listening window to the sleep window.

When an error occurs in the retransmitted data received by the terminal, the terminal discards the corresponding data and attempts to transmit the NACK feedback. However, since the current window is the sleep window, the abandons HARQ feedback transmission and is then operated in the sleep mode. In this instance, since the base station fails to receive feedback for the second data from the terminal, it has to discard the corresponding data or retransmit them in the next listening window.

Having received the data without an error, the terminal stores the data and attempts to transmit an ACK feedback. However, since the current window is the sleep window, the terminal abandons HARQ feedback transmission and is then operated in the sleep mode. Since the base station fails to receive the second data feedback from the terminal, it has to discard the corresponding data or retransmit them in the next listening window.

Therefore, the conventional art may lose data, increase a data transmission time delay, or waste a radio resource by repeatedly transmitting the same data.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide an efficient power saving operation management method for increasing power saving efficiency of a terminal by reducing power consumption in a section with no data transmission in a wideband wireless access system.

### Technical Solution

An exemplary embodiment of the present invention provides a method for a base station to manage a power saving operation method including: receiving a sleep mode entering request message from a mobile station desiring to enter a sleep mode; determining a sleep period type and a parameter by analyzing a combination of radio channels that are set between the mobile station and the base station; and transmitting a sleep mode entering response message including the sleep period type and the parameter.

Another embodiment of the present invention provides a method for a mobile station to manage a power saving operation including: transmitting a sleep mode entering request message; receiving a sleep mode entering response message including a sleep period type and a parameter; and setting a parameter of the sleep mode according to the parameter included in the sleep mode entering response message, and entering the sleep mode.

Yet another embodiment of the present invention provides a method for a base station to manage a power saving operation including: determining whether to change a sleep period type when part of radio channels between the base station and a mobile station is deleted or a new radio channel is established; determining the sleep period type and a parameter when a change is needed; transmitting the sleep period change request message including the sleep period type and the parameter to the mobile station; and receiving the sleep period change response message from the mobile station.

### ADVANTAGEOUS EFFECTS

According to the present invention, complexity for managing the sleep mode can be reduced by selecting one efficient sleep period type according to a characteristic of a radio channel set for each mobile station and managing the sleep mode, and power saving efficiency can be increased by preventing intermittent control message transmission and uplink transmission, and stoppage of unneeded power saving operation caused by HARQ retransmission.

### DESCRIPTION OF DRAWINGS

FIG. 1 shows a flowchart of a conventional sleep mode operation performance.

FIG. 2 shows an available section and an unavailable section of a mobile station operable in a sleep mode.

FIG. 3 shows a flowchart of an HARQ operation in the case of a sleep mode operation in a conventional wideband wireless access system.

FIG. 4 shows a flowchart of a sleep mode entering/canceling method in a power saving operation management method according to an exemplary embodiment of the present invention.

FIG. 5 shows a flowchart of a sleep mode entering/canceling method by a mobile station in a power saving operation management method according to an exemplary embodiment of the present invention.

FIG. 6 shows a flowchart of a sleep mode entering method by a base station in a power saving operation management method according to an exemplary embodiment of the present invention.

FIG. 7 shows a flowchart of a sleep period management and uplink/downlink data transmission operation of a sleep period type II in a power saving operation management method according to an exemplary embodiment of the present invention.

FIG. 8 shows a flowchart of a sleep period management and uplink/downlink data transmission operation of a sleep period type I in a power saving operation management method according to an exemplary embodiment of the present invention.

FIG. 9 shows a flowchart of an uplink data transmission process by a mobile station for operating a sleep mode with a sleep period type I in a power saving operation management method according to an exemplary embodiment of the present invention.

FIG. 10 shows a process for changing from a sleep period type II to a sleep period type I in a power saving operation management method according to an exemplary embodiment of the present invention.

FIG. 11 shows a flowchart of a sleep period type changing method by a base station in a power saving operation management method according to an exemplary embodiment of the present invention.

FIG. 12 shows a flowchart of a sleep period type changing method by a mobile station in a power saving operation management method according to an exemplary embodiment of the present invention.

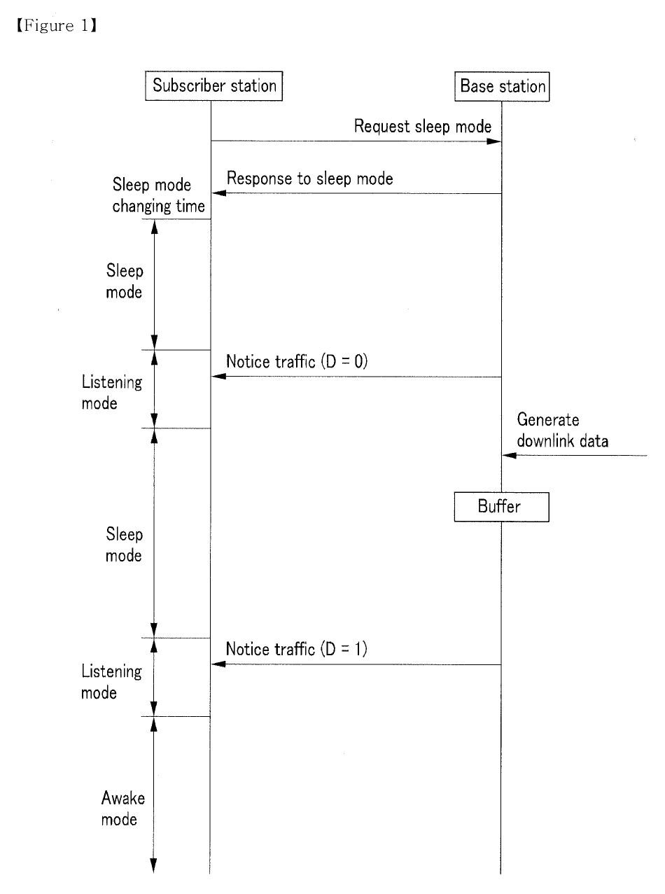

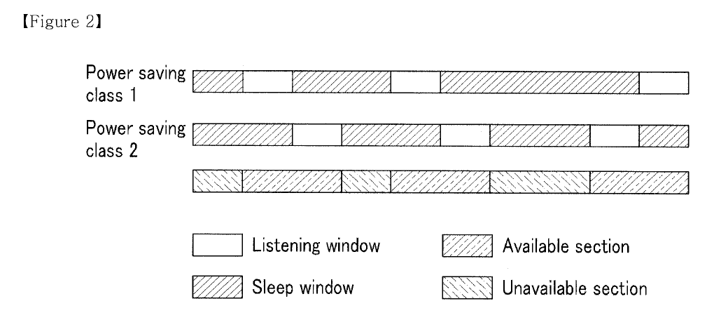

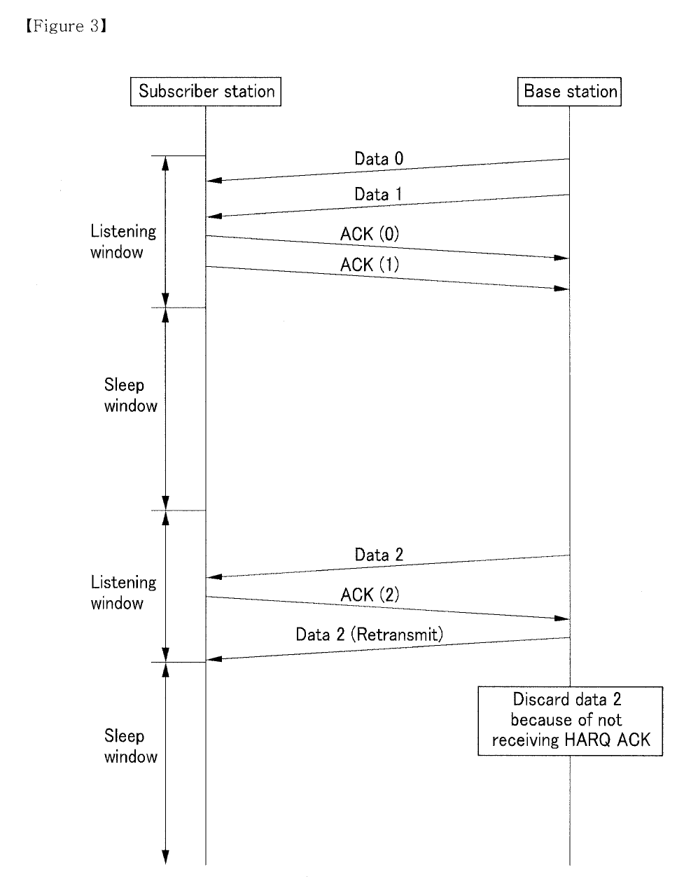

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. Also, the terms of a unit, a device, and a module in the present specification represent a unit for processing a predetermined function or operation, which can be realized by hardware, software, or combination of hardware and software.

In the specification, a mobile station (MS) may indicate a terminal, a mobile terminal (MT), a subscriber station (SS), a portable subscriber station (PSS), user equipment (UE), and an access terminal (AT), and may include entire or partial functions of the mobile terminal, subscriber station, portable subscriber station, user equipment, and access terminal.

A base station (BS) may indicate an access point (AP), a radio access station (RAS), a nodeB (Node B), a base transceiver station (BTS), and a mobile multihop relay (MMR)-BS, and may include entire or partial functions of the access point, radio access station, nodeB, base transceiver station, and MMR-BS.

A power saving operation management method according to an exemplary embodiment of the present invention uses a sleep period type for each terminal according to traffic characteristics of radio channels established between a terminal and a base station.

Two sleep period types of a power saving operation management method according to an exemplary embodiment of the present invention will now be described. The power saving operation management method according to the exemplary embodiment of the present invention has two sleep period types.

The sleep period type I is used for burst uplink/downlink data transmission or intermittent uplink/downlink bandwidth allocation. Therefore, the sleep period type I can be used when it is satisfied with the condition that characteristics of traffic channels in radio channels established between a terminal and a base station are best effort (BE) traffic having the characteristics of, the existing Internet traffic or non-real-time variable rate (nrt-VR) traffic with a variable data rate. More specifically, when the radio channels are configured with only the traffic channels satisfying the condition, when the radio channels are configured with the traffic channels satisfying the condition and control channels, or when the radio channels are configured with only control channels, the sleep period type I can be used.

Parameters for defining the sleep period type I include a listening window, a sleep window, a sleep window base, and a start frame number of the sleep window.

The sleep period type II is used for periodical uplink/downlink data transmission or periodical uplink/downlink bandwidth allocation. Therefore, it is used when the traffic characteristics of at least one radio channel among the radio channels that are established between the terminal and the base station is real-time traffic characteristics such as a VoIP or a real-time variable rate (rt-VR) with a variable data rate. Parameters for defining the sleep period type II include a listening window, a sleep window, and a start frame number for the sleep window.

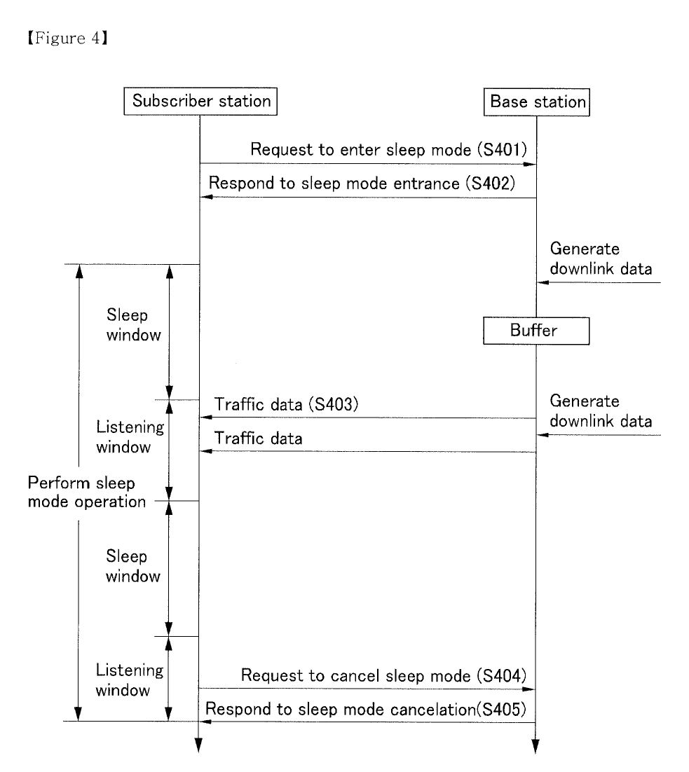

A sleep mode entering/canceling method in a power saving operation management method according to an exemplary embodiment of the present invention will now be described with reference to FIG. 4 to FIG. 6.

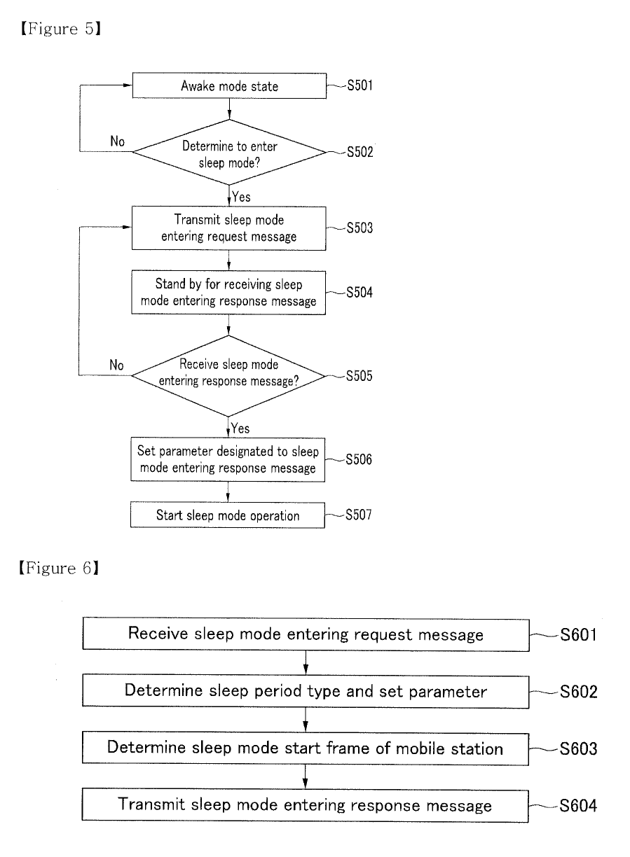

FIG. 4 shows a flowchart of a sleep mode entering/canceling method in a power saving operation management method according to an exemplary embodiment of the present invention. FIG. 5 shows a flowchart of a sleep mode entering method by a mobile station in a power saving operation management method according to an exemplary embodiment of the present invention, and FIG. 6 shows a flowchart of a sleep mode entering method by a base station in a power saving operation management method according to an exemplary embodiment of the present invention.

As shown in FIG. 4, when a mobile station attempting to enter the sleep mode operation transmits a sleep mode entering request message to a base station (S401), the base station transmits a sleep mode entering response message to the mobile station (S402) to approve the sleep mode.

Referring to FIG. 5, when staying in an awake mode state 5501 and then determining to enter the sleep mode (S502), the mobile station transmits a sleep mode entering request message to the base station (S503) and stands by for receiving a sleep mode entering response message (S504). When receiving the sleep mode entering response message (S505), the mobile station sets a parameter of the sleep mode according to a parameter designated to the sleep mode entering response message (S506) and starts the sleep mode operation (S507). A sleep mode entering time represents a frame that corresponds to a start frame having a low-order bit value of a frame number included in the sleep mode entering response message.

Referring to FIG. 6, when a sleep mode entering request message is received from the terminal (S601), the base station analyzes a combination of radio channels between the mobile station and the base station to determine the sleep period type, and determines a parameter for defining the determined sleep period type (S602). The base station determines a sleep mode start frame of the mobile station (S603), and transmits a sleep mode entering response message including the parameter for defining the sleep period and the sleep mode start frame (S604).

When downlink traffic occurs while the mobile station is operated in the sleep mode, the base station buffers the traffic and transmits it in the listening section of the mobile station (S403).

In the prior art, while the terminal enters the sleep mode when there is no uplink/downlink data communication, the power saving operation management method according to the exemplary embodiment of the present invention allows the terminal to enter the sleep mode during data communication according to power saving needs, and allows uplink/downlink data communication during the sleep mode.

Therefore, the terminal having entered the sleep mode consecutively performs the sleep mode operation when the terminal or the base station does not request termination of the sleep mode specifically. The mobile station attempting to stop the sleep mode operation transmits a sleep mode cancellation request message to the base station S404, and stops the sleep mode operation (S405) when normally receiving a sleep mode cancellation response message from the base station.

The mode entering/canceling request message and the sleep mode entering/canceling response message will now be described.

Table 1 expresses a sleep mode entering/canceling request message of a power saving operation management method according to an exemplary embodiment of the present invention.

TABLE 1

| Syntax | Size | Notes |
|---|---|---|
| Operation | 1 | 0: to deactivate power saving operation |
| | | 1: to activate power saving operation |
| Sleep Interval Type | 1 | 0: Sleep Interval Type I |
| | | 1: Sleep Interval Type II |
| Action Code | 1 | 0: Request from MS |
| | | 1: Response to BS |
| Reserved | 5 | Shall be set to zero |

As expressed in Table 1, the sleep mode entering/canceling request message includes information (Operation) on the drive and stop of the sleep mode operation of the subscriber station, sleep period type information (Sleep Interval type), and a message transmission object (Action Code).

Table 2 expresses a sleep mode entering/canceling response message of a power saving operation management method according to an exemplary embodiment of the present invention,

TABLE 2

| Syntax | Size | Notes |
|---|---|---|
| Operation | 1 | 1: to activate power saving operation |
| | | 0: to deactivate the activated power |
| | | saving operation |
| Sleep Interval Type | 1 | 0: Sleep Interval Type I |
| | | 1: Sleep Interval Type II |
| Start Frame | 6 | 6 LSB of frame number to start |
| | | activation of power saving operation |
| Listening Window | 8 | Length of listening window |
| Sleep Window | 8 | |
| Sleep Window Exponent | 3 | |
| Sleep Window Base | 7 | |
| Decreasing Ratio | 5 | 0: No decreasing |
| | | 1; 1 |
| | | 2: ½ |
| | | 3-31: Reserved |
| Action Code | 1 | 0: Request from BS |
| | | 1: Response to MS |

As expressed in Table 2, the sleep mode entering/canceling response message includes information (Operation) on the drive and stop of the sleep mode operation of the subscriber station, a sleep period type (Sleep Interval Type) to be used by the terminal, a sleep period defining parameter, and a message transmission object (Action Code).

In this instance, the sleep period defining parameters includes a listening window, a sleep window, a sleep window exponent, a sleep window base, a sleep window decreasing ratio, and a start frame of the sleep period.

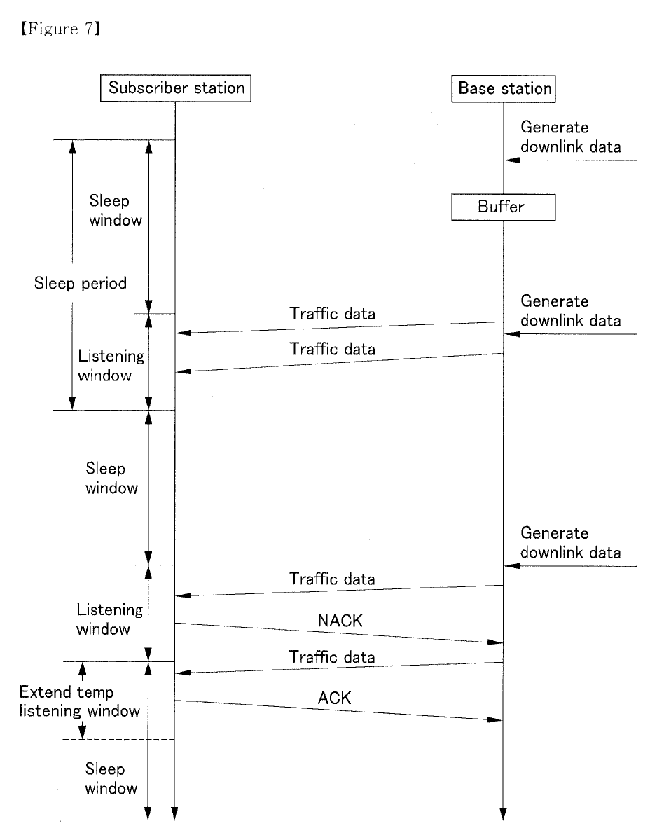

A sleep period management and uplink/downlink data transmission operation for each sleep period type in a power saving operation management method according to an exemplary embodiment of the present invention will now be described with reference to FIG. 7 to FIG. 9.

FIG. 7 shows a flowchart of a sleep period management and uplink/downlink data transmission operation of a sleep period type II in a power saving operation management method according to an exemplary embodiment of the present invention.

Referring to FIG. 7, regarding the sleep period type II, a sleep period includes a size-fixed listening window and a size-fixed sleep window, and a sleep period with a predetermined size is repeatedly performed during the sleep mode operation. During the sleep window section, no uplink/downlink communication between the terminal and the base station is performed.

The base station buffers the data received during the sleep window and transmits them to the terminal during the next listening window section. When the data to be transmitted to the base station are generated during the sleep window in the case of an uplink, the terminal transmits a corresponding uplink during the next listening window. Therefore, the terminal's power consumption is reduced during the sleep window section since no communication occurs in the terminal.

However, when uplink or downlink data transmission during the listening window cannot be finished before the listening window is terminated, the current listening window is temporarily expanded as an exceptional case to finish data transmission during the sleep window.

Referring to FIG. 7, an HARQ feedback for the data received from the base station must be transmitted in the second listening window, but when the current listening window is finished and no transmission is available, the current listening window is temporarily extended to finish the current data transmission and perform the sleep window. In this instance, since the size of the temporarily extended listening window does not influence the next sleep period, the size of the next sleep window is given by subtracting the extended listening window from the original sleep window size.

When the data are transmitted during the listening window and the data transmission is not finished, power consumption of the subscriber station is reduced by extending the listening window without cancelling the sleep mode operation and simultaneously data loss or increase of data transmission time delay that may occur when the subscriber station manages the sleep window can be prevented.

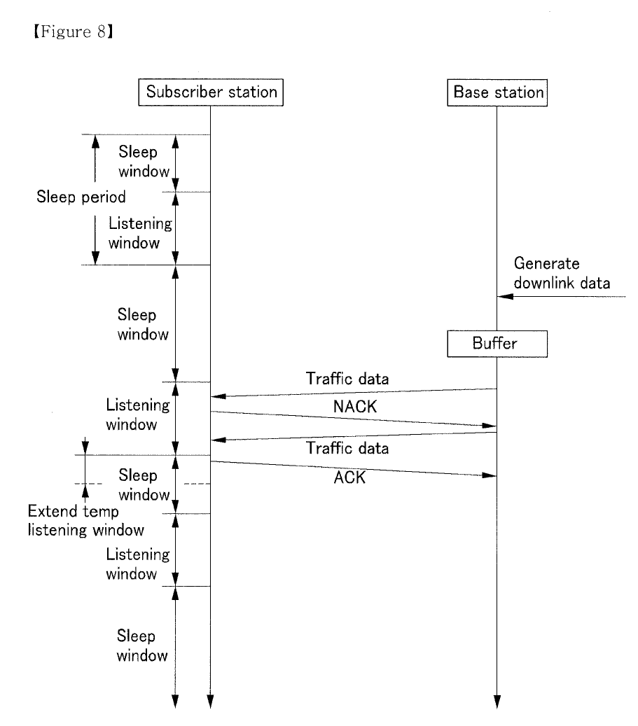

FIG. 8 shows a flowchart of a sleep period management and uplink/downlink data transmission operation of a sleep period type I in a power saving operation management method according to an exemplary embodiment of the present invention.

Referring to FIG. 8, the sleep period type I is configured with a listening window and a sleep window in a like manner of the sleep period type II. However, differing from the sleep period type II, the size of the sleep window of the next sleep period is determined according to a generation state of downlink data transmission during the listening window of the previous sleep period. In the case of the second sleep period of FIG. 8, since no downlink data communication is generated during the listening window of the first sleep period, the size of the sleep window of the second sleep period is increased to double the sleep window of the first sleep period. In addition, since downlink data transmission is generated in the listening window of the second sleep period, the sleep window size of the third sleep period is determined by applying the defined sleep window decreasing ratio to the sleep window size of the second sleep period.

Uplink/downlink data transmission generated in the listening window of the sleep period type I is performed in a like manner of the sleep period type II. That is, when downlink transmission cannot be finished before the listening window is terminated, the listening window is temporarily extended as an exceptional case to finish data transmission in the sleep window.

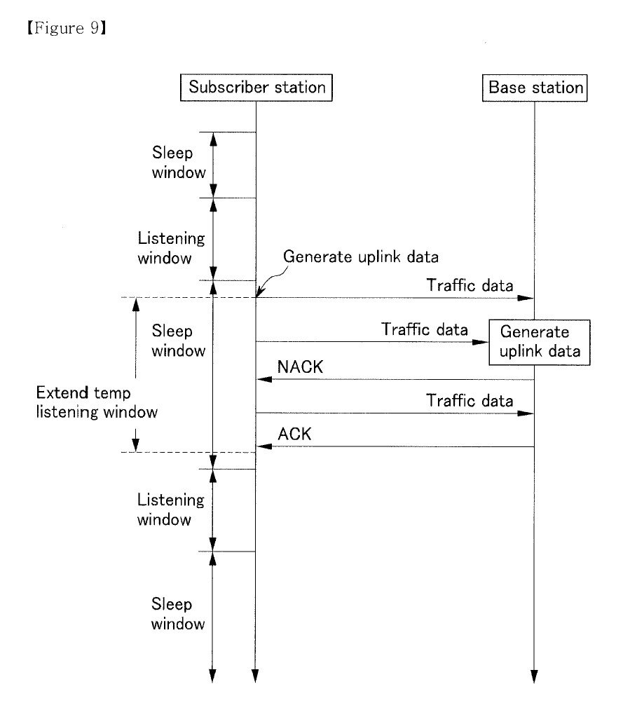

FIG. 9 shows a flowchart of an uplink data transmission process by a mobile station for operating a sleep mode with a sleep period type I in a power saving operation management method according to an exemplary embodiment of the present invention.

Referring to FIG. 9, differing from the sleep period type II for performing uplink transmission in the listening window, the sleep period type I can transmit uplink data irrespective of the current window types. In this case, when uplink transmission is needed as the listening window is temporarily extended for downlink transmission, the listening window is temporarily allocated until uplink transmission is finished, and the allocated listening window does not influence the method of determining the above-noted sleep window size.

For example, when uplink data occur during the sleep window in a like manner of the second sleep period of FIG. 9, the terminal transmits an uplink bandwidth request message for uplink data transmission to the base station. The base station receives the uplink bandwidth request message from the mobile station in the sleep window, allocates a bandwidth required by the terminal, and determines that the terminal will temporarily stay in the listening window section until uplink transmission of data to the allocated bandwidth is finished. When the uplink transmission is finished, the terminal and the base station enter the sleep window, and since the temporarily allocated listening window does not influence next sleep window allocation, they stand by for uplink/downlink data transmission by switching from the sleep window to the listening window in the next listening window as determined in the previous sleep period.

According to the exemplary embodiment of the present invention, the terminal's power consumption can be efficiently managed by managing the sleep period according to the burst traffic characteristic. Also, power consumption and delay of uplink data transmission are reduced compared to the prior art by maintaining the power saving operation in the case of intermittent uplink transmission.

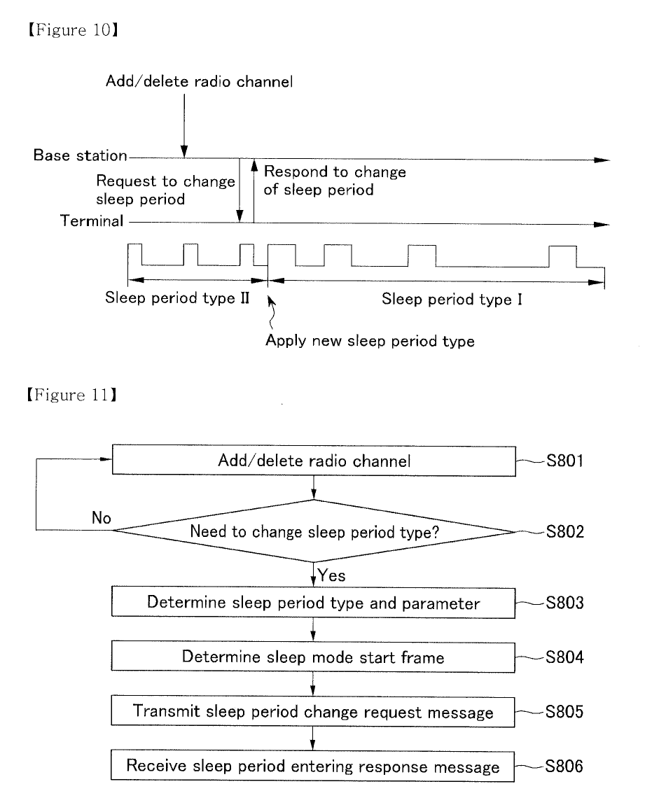

A method for changing a period type in a power saving operation management method according to an exemplary embodiment of the present invention will now be described with reference to FIG. 10 to FIG. 12.

FIG. 10 shows a process for changing from a sleep period type II to a sleep period type I in a power saving operation management method according to an exemplary embodiment of the present invention.

Referring to FIG. 10, when it is needed to switch to the sleep period type I because combination of radio channels established between the base station and the terminal is changed while performing the power saving operation by using the sleep period type II, the base station transmits a sleep period change request message to the terminal to request a change of the sleep period type. In this instance, the transmitted sleep period change request message includes a parameter for defining the sleep period type in a like manner of the sleep mode entering response message that is transmitted for entering the sleep mode.

When receiving the sleep period change request message for requesting a change of the sleep period type, the terminal transmits a sleep period change response message to respond to the sleep period type change request.

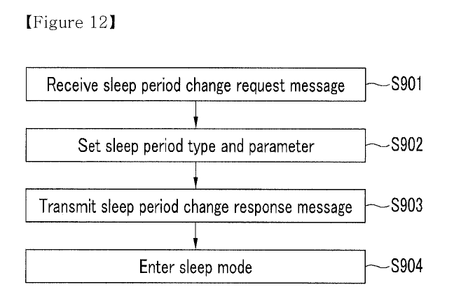

FIG. 11 shows a flowchart of a sleep period type changing method by a base station in a power saving operation management method according to an exemplary embodiment of the present invention, and FIG. 12 shows a flowchart of a sleep period type changing method by a mobile station in a power saving operation management method according to an exemplary embodiment of the present invention.

Referring to FIG. 11, when part of the radio channels established between the mobile station and the base station are deleted or a new radio channel is set (S801), the base station checks whether to change the sleep period type (S802). For example, when a radio channel for transmitting real-time traffic and a radio channel for transmitting BE traffic are set between the mobile station and the base station, the power saving operation is performed with the sleep period type II, and a radio channel for transmitting real-time traffic is terminated, the base station checks whether to change the sleep period type based on the combination of the radio channels that are currently established. In this case, since the radio channel established between the terminal and the base station supports only the BE traffic, the base station determines to change to the sleep period type I.

When a change is needed, the base station determines the sleep period type and the parameter (S803), and then determines the sleep mode start frame (S804). The base station transmits a sleep period change request message to the mobile station (S085), and receives a sleep period change response message from the mobile station (S806).

Referring to FIG. 12, when receiving the sleep period change request message (S901), the mobile station sets the sleep period type and the parameter designated in the sleep period change request message (S902), transmits a sleep period change response message to the base station (S903), and enter the sleep mode (S904).

It has been described in the exemplary embodiment of the present invention that the base station requests to change the sleep period and the terminal responds to it, and further, the terminal can request to change the sleep period and the base station can respond to it.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for a base station to manage a power saving operation, comprising:
receiving a sleep mode entering request message from a mobile station desiring to enter a sleep mode;
determining a sleep period type and a parameter by analyzing a combination of radio channels that are set between the mobile station and the base station; and
transmitting a sleep mode entering response message including the sleep period type and the parameter.

2. The method of claim 1, wherein
the determining of a sleep period type and a parameter includes:
determining as a first sleep period type when radio channels that are set between the mobile station and the base station have a burst characteristic; and
determining as a second sleep period type when one of the radio channels that are set between the mobile station and the base station have a periodical characteristic.

3. The method of claim 1, wherein
the sleep mode includes a sleep window representing a section in which no communication is performed between the mobile station and the base station, and a listening window representing a section in which communication is performed between the mobile station and the base station.

4. The method of claim 3, further comprising
buffering the downlink data and transmitting the same during the listening window when downlink data are generated during the sleep window, and extending the listening window and transmitting the downlink data transmission when the downlink data transmission is not finished during the listening window.

5. A method for a mobile station to manage a power saving operation, comprising:
transmitting a sleep mode entering request message;
receiving a sleep mode entering response message including a sleep period type and a parameter; and
setting a parameter of the sleep mode according to the parameter included in the sleep mode entering response message, and entering the sleep mode.

6. The method of claim 5, wherein
the sleep period type is a first sleep period type when radio channels that are set between the mobile station and the base station have a burst characteristic, and it is a second sleep period type when one of the radio channels that are set between the mobile station and the base station have a periodical characteristic.

7. The method of claim 6, wherein
the sleep mode includes a sleep window representing a section in which no communication is performed between the mobile station and the base station, and a listening window representing a section in which communication is performed between the mobile station and the base station, and
when the sleep period type is a second sleep period type, the listening window with a predetermined size and the sleep window with a predetermined size of the sleep mode are alternately performed.

8. The method of claim 6, wherein
the sleep mode includes a sleep window representing a section in which no communication is performed between the mobile station and the base station, and a listening window representing a section in which communication is performed between the mobile station and the base station, and
when the sleep period type is a first sleep period type, the size of the sleep window is determined according to downlink data transmission during a previous listening window.

9. The method of claim 8, wherein
when the sleep period type is a first sleep period type,
the size of the sleep window is determined by a predefined ratio when the downlink data are transmitted during the previous listening window, and the size thereof is greater than that of the previous sleep window when the downlink data are not transmitted during the previous listening window.

10. The method of claim 8, further comprising
transmitting the uplink data by temporarily allocating a listening window when uplink data are generated during the sleep window.

11. A method for a base station to manage a power saving operation, comprising:
determining whether to change a sleep period type when a part of radio channels between the base station and a mobile station is deleted or a new radio channel is established;
determining the sleep period type and a parameter when a change is needed;
transmitting the sleep period change request message including the sleep period type and the parameter to the mobile station; and
receiving the sleep period change response message from the mobile station.
